(19) United States
(12) Patent Application Publication
(10) Pub. No.: US 2020/0334544 A1
(43) Pub. Date: Oct. 22, 2020

(54) METHOD, DEVICE AND COMPUTER PROGRAM PRODUCT FOR PROCESSING MACHINE LEARNING MODEL

(71) Applicant: EMC IP Holding Company LLC, Hopkinton, MA (US)

(72) Inventors: Jinpeng Liu, Shanghai (CN); Pengfei Wu, Shanghai (CN); Zhi Ying, Shanghai (CN); Kun Wang, Beijing (CN)

(21) Appl. No.: 16/542,757

(22) Filed: Aug. 16, 2019

(30) Foreign Application Priority Data
Apr. 19, 2019 (CN) 201910318463.5

(51) Int. Cl. G06N 3/10; G06N 3/04; G06F 9/48; G06F 8/41

(52) U.S. Cl. CPC G06N 3/105; G06F 8/41; G06F 9/4881; G06N 3/04

(57) ABSTRACT

A method comprises obtaining an intermediate representation of a machine learning model written in a source language, the intermediate representation being independent of the source language and a target language and comprising a computation graph described by a structured text, a node in the computation graph representing a function associated with the machine learning model. The method comprises sending the intermediate representation to a scheduler to obtain indication information related to a plurality of dedicated processing resources for executing the machine learning model. The method further comprises generating a plurality of runtime libraries corresponding to the plurality of dedicated processing resources to process data related to the machine learning model based on the intermediate representation and the indication information, a runtime library comprising functions represented in the target language. General applicability of the compiler is increased, and assignment of the machine learning model on different dedicated processing resources is facilitated.

### RELATED APPLICATION(S)

The present application claims priority to Chinese Patent Application No. 201910318463.5, filed Apr. 19, 2019, and entitled “Method, Device and Computer Program Product for Processing Machine Learning Model,” which is incorporated by reference herein in its entirety.

### FIELD

Embodiments of the present disclosure generally relate to the field of artificial intelligence, and more specifically, to a method, a device and a computer program product for processing a machine learning model.

### BACKGROUND

In recent years, with the advance of artificial intelligence technologies, machine learning or deep learning (DL) has driven development in many fields. Meanwhile, while machine learning models become increasingly sophisticated, and a larger dataset is needed, more computation resources are needed for executing such machine learning models. At present, it is almost impossible for a single machine to meet requirements of a large-scale machine learning model in terms of computation capacity due to the limitation of computation capacity of a central processing unit (CPU) and communication bandwidth between the CPU and peripheral computing devices. Therefore, how to effectively deploy a machine learning model has become a current focus of interest.

### SUMMARY

Embodiments of the present disclosure provide a method, a device and a computer program product for processing a machine learning model.

According to a first aspect of the present disclosure, provided is a method of processing a machine learning model. The method comprises obtaining an intermediate representation of a machine learning model written in a source language, the intermediate representation being independent of the source language and a target language and comprising a computation graph described by a structured text, a node in the computation graph representing a function associated with the machine learning model. The method further comprises sending the intermediate representation to a scheduler to obtain indication information related to a plurality of dedicated processing resources for executing the machine learning model. The method further comprises generating a plurality of runtime libraries corresponding to the plurality of dedicated processing resources to process data related to the machine learning model based on the intermediate representation and the indication information, a runtime library comprising functions represented in the target language.

According to a second aspect of the present disclosure, provided is a method of executing a machine learning model. The method comprises receiving, at a first device, data to be processed by the machine learning model. The method further comprises sending the received data to a first dedicated processing resource of the first device, so that the first dedicated processing resource processes the data by executing a first group of functions among a plurality of functions related to the machine learning model, the first group of functions being comprised in a first runtime library accessible to the first device, the first runtime library being generated by a method according to the first aspect of the present disclosure. The method further comprises sending the data which have been processed by the first dedicated processing resource to a second device for processing.

According to a third aspect of the present disclosure, provided is an electronic device for processing a machine learning model. The electronic device comprises: a processor; and a memory storing computer program instructions, the processor running the computer program instructions in the memory to control the electronic device to perform acts, including: obtaining an intermediate representation of a machine learning model written in a source language, the intermediate representation being independent of the source language and a target language and comprising a computation graph described by a structured text, a node in the computation graph representing a function associated with the machine learning model; sending the intermediate representation to a scheduler to obtain indication information related to a plurality of dedicated processing resources for executing the machine learning model; and generating a plurality of runtime libraries corresponding to the plurality of dedicated processing resources to process data related to the machine learning model based on the intermediate representation and the indication information, a runtime library comprising functions represented in the target language.

According to a fourth aspect of the present disclosure, provided is an electronic device for executing a machine learning model. The electronic device comprises: a processor; and a memory storing computer program instructions, the processor running the computer program instructions in the memory to control the electronic device to perform acts, including: receiving, at a first device, data to be processed by the machine learning model; sending the received data to a first dedicated processing resource of the first device, so that the first dedicated processing resource processes the data by executing a first group of functions among a plurality of functions related to the machine learning model, the first group of functions being comprised in a first runtime library accessible to the first device, the first runtime library being generated by a method according to the first aspect of the present disclosure; and sending the data which have been processed by the first dedicated processing resource to a second device for processing.

According to a fifth aspect of the present disclosure, provided is a computer program product. The computer program product is tangibly stored on a non-transient computer readable medium and comprises machine executable instructions which, when being executed, causing a machine to perform steps of the method according to the first aspect of the present disclosure.

According to a sixth aspect of the present disclosure, provided is a computer program product. The computer program product is tangibly stored on a non-transient computer readable medium and comprises machine executable instructions which, when being executed, causing a machine to perform steps of the method according to the second aspect of the present disclosure.

### BRIEF DESCRIPTION OF THE DRAWINGS

Through more detailed description of example embodiments of the present disclosure with reference to the accompanying drawings, the above and other objects, features and advantages of the present disclosure will become more apparent, wherein the same reference numerals typically represent the same components in the example embodiments of the present disclosure.

FIG. 1 shows a schematic diagram of an example environment in which a device and/or a method can be implemented according to embodiments of the present disclosure;

FIG. 2 shows a schematic diagram of a computation graph according to embodiments of the present disclosure;

FIG. 3 shows a flowchart of a method for compiling a machine learning model according to embodiments of the present disclosure;

FIG. 4 shows a schematic diagram of an example environment in which a device and/or a method can be implemented according to embodiments of the present disclosure;

FIG. 5 shows a flowchart of a method for processing data with a machine learning model according to embodiments of the present disclosure;

FIG. 6 shows a schematic block diagram of an example device which is applicable to implement embodiments of the present disclosure.

Throughout the figures, the same or corresponding numerals denote the same or corresponding parts.

### DETAILED DESCRIPTION

Embodiments of the present disclosure will be described in more detail with reference to the accompanying drawings. Although the drawings illustrate some embodiments of the present disclosure, it should be understood that the present disclosure can be implemented in various manners, and should not be construed to be limited to embodiments disclosed herein. On the contrary, those embodiments are provided for thorough and complete understanding of the present disclosure. It should be understood that the accompanying drawings and embodiments of the present disclosure are only for illustration purposes, without suggesting any limitation to the protection scope of the present disclosure.

When describing embodiments of the present disclosure, the terms “include” and its variants used herein are to be read as open terms that mean “include, but is not limited to.” The term “based on” is to be read as “based at least in part on”. The terms “one embodiment” and “the embodiment” are to be read as “at least one embodiment.” The term “another embodiment” is to be read as “at least one other embodiment.” The terms “first,” “second” and the like may refer to different or the same objects. Other definitions, explicit and implicit, might be included below.

Principles of the present disclosure will be described with reference to several example embodiments shown in the accompanying drawings, in which the preferable embodiments of the present disclosure have been illustrated. However, it should be understood that these embodiments are described only for enabling those skilled in the art to better understand and further implement the present disclosure, rather than suggesting any limitation to the scope of the present disclosure in any manner.

When a machine learning model is used to process data, initially data parallelism is adopted. By this means, each machine runs a machine learning model to process a part of data. However, with the development of a machine learning model, it is impossible for a whole machine learning model to run in a single computing device. Therefore, model parallelism is used to run a large and sophisticated machine learning model.

Usually, program developers write a machine learning model program with a specific framework and define a neural network layer by layer. Therefore, when processing a machine learning model with model parallelism, usually different layers in the machine learning model are distributed among different computing devices. However, a framework or a compiler usually generates a single binary program when compiling the machine learning model program. In this case, the program has very little information about how layers are organized. It is difficult for both the framework and the developer to split the whole computation task for this single binary program into different computation nodes.

Furthermore, in different neural networks, parameters are organized in different parameter formats, e.g., parameter formats are different in a convolution neural network (CNN) and a recurrent neural network (RNN). Even in the same type of neural network (e.g., CNN), due to a different number of layers and different nodes in a layer, different partition schemes will result in different parameter formats. Therefore, there is no uniform way to realize the synchronization of parameters.

To overcome the above problems, the present disclosure proposes a method of processing a machine learning model. In this method, an intermediate representation of the machine learning model written in a source language is obtained. The intermediate representation comprises functions associated with the machine learning model. Then, the intermediate representation is sent to a scheduler to obtain types of a plurality of dedicated processing resources executing the machine learning model. Next, for each type of dedicated processing resource, a runtime library for the type of dedicated processing resource is generated. When running the machine learning model, different functions are running on different dedicated processing resources of different devices, and function parameters are passed between different devices. In this way, programs written in different languages and from different frameworks may be compiled, thereby improving universality of compilers. Moreover, the simplicity for deployment of a machine learning model is improved by deploying the machine learning model based on functions.

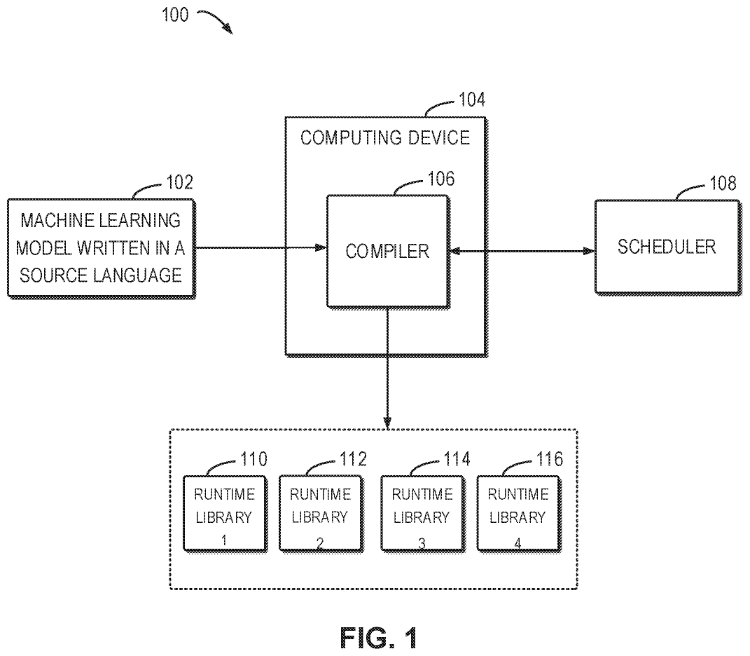

FIG. 1 shows a schematic diagram of an example environment 100 in which a device and/or a method can be implemented according to embodiments of the present disclosure.

As shown in FIG. 1, the example environment 100 comprises a computing device 104 and a scheduler 108. The computing device 104 may receive a machine learning model 102 written in a source language. In some embodiments, the machine learning model 102 written in the source language may be written in different source languages. For example, these source languages may include, but are not limited to, CUDA, Java, Python, C++, Fortran, Ada, C#, etc. In some embodiments, the machine learning model 102 written in a source language may be determined by different frameworks. The above examples are merely for describing the present disclosure, without suggesting any limitation to the scope of the present disclosure.

In some embodiments, a user (e.g., a machine learning model developer) may send the machine learning model 102 written in the source language to the computing device 104 via a personal computing device. In some embodiments, the computing device 104 may also obtain source codes of the machine learning model to-be-executed from a coupled device. The above examples are merely for describing the present disclosure, without suggesting any limitation to the scope of the present disclosure. The computing device 104 may obtain the machine learning model 102 based on any appropriate means.

The computing device 104 includes a compiler 106. In some embodiments, the compiler 106 may be used to compile the machine learning model into a corresponding intermediate representation. Compiling refers to a process that transforms source codes/original codes written in a programming language into machine codes or local codes under a target architecture. The intermediate representation is a data structure or codes used by the compiler or a virtual machine which are used to represent source codes, and is independent of (i.e., irrelevant to, agnostic with respect to, etc.) source language and target language. A model written in source language may be compiled into the intermediate representation. In some embodiments, the intermediate representation of the machine learning model may be obtained by other means, e.g., a programmer writes the machine learning model written in the source language into the intermediate representation of the machine learning model according to the compiling rule of the complier. The foregoing example is merely for describing the present disclosure rather than limiting the same. The intermediate representation of the machine learning model written in the source language may be obtained by any appropriate means.

In some embodiments, the intermediate representation may include a computation graph described in a structured text. For example, the intermediate representation may include a computation graph of a machine learning model to-be-executed which is described in a format of JavaScript object notation (JSON) or extensible markup language (XML). Nodes in the computation graph represent functions associated with the machine learning model. The computation graph further includes dependencies between functions.

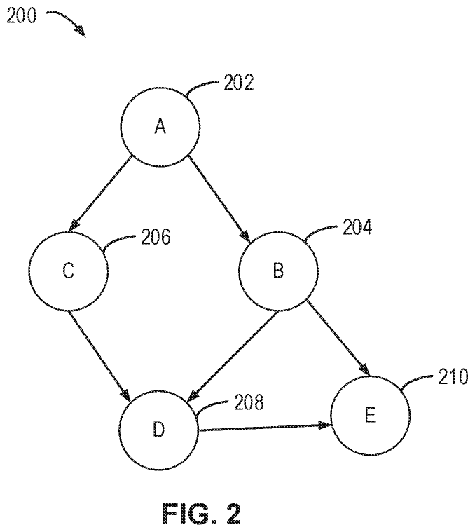

As an example, FIG. 2 shows a computation graph 200 including five nodes A202, B204, C206, D208 and E210. In the computation graph, each node represents one function in the machine learning model, and connection lines between nodes represent dependencies between functions. For example, parameters of node A202 are passed to nodes B204 and C206, parameters of node C206 are passed to node D208, and so on as illustrated. FIG. 2 describes the computation graph only by way of example. The number of nodes in the computation graph and the structure of the computation graph may be provided as any appropriate form based on demands.

The compiler 106 passes the obtained intermediate representation to the scheduler 108 and obtains indication information on dedicated processing resources for processing the machine learning model.

In some embodiments, the indication information includes the number of computing resources used for the machine learning model and types of corresponding computing resources. Alternatively or additionally, the indication information may further include any appropriate information.

With respect to each dedicated processing resource used for the machine learning model, the compiler 106 generates runtime libraries corresponding to the type of the dedicated processing resources based on the intermediate representation of the machine learning model and the indication information obtained from the scheduler 108. The runtime library is a special computer program library which is used by the compiler to implement built-in functions of a program so as to provide support when the program is running.

In some embodiments, each runtime library includes functions in the computation graph represented in a target language. Alternatively or additionally, each runtime library includes each function in the computation graph.

The example of FIG. 1 shows four runtime libraries generated by the compiler 106: runtime library 1 110, runtime library 2 112, runtime library 3 114 and runtime library 4 116. Each runtime library is directed to each type of dedicated processing resource and includes all functions in the computation graph represented in a target language. The foregoing example is merely to illustrate the disclosure rather than limiting the disclosure. The compiler 106 may generate any appropriate number of runtime libraries based on the number and type of dedicated processing resource determined by the scheduler 108.

In some embodiments, besides the runtime library for the dedicated processing resource, the compiler 106 further generates host program code running on a host managing the dedicated processing resource. In some embodiments, the runtime library running on each dedicated processing resource corresponds to one host program running on a host controlling the dedicated processing resource. The host runs the host program assigned to the host, so as to control the dedicated processing resource to process a function of the machine learning machine assigned to it and to receive data from and send data to different hosts.

In one example, the host program may be directly written by a programmer. In another example, the host program may be generated by the compiler 106 and them modified by the programmer. In a further example, the host program may be generated by the scheduler 108.

The scheduler 108 may determine the number and types of dedicated processing resources used to run the machine learning model, based on the obtained intermediate representation. In some embodiments, the dedicated processing resource may be a GPU, a FPGA or an ASIC, etc. In some embodiments, the scheduler 108 may determine, based on the intermediate representation, which dedicated processing resources are used to process which functions in the machine learning model, as well as types of these dedicated processing resources.

One example will be described in conjunction with FIG. 2. The scheduler 108 may determine, based on the intermediate representation, the first dedicated processing resource processes a function of node A202, the second dedicated processing resource processes functions of nodes B204 and C206, the third dedicated processing resource processes a function of node D208, and the fourth dedicated processing resource processes a function of node E210. Therefore, the scheduler 108 determines four dedicated processing resources process the intermediate representation, and further determines types of these four dedicated processing resources. The above example is merely for describing the present disclosure rather than limiting the same. The scheduler 108 may determine the number and types of dedicated processing resources based on any appropriate method.

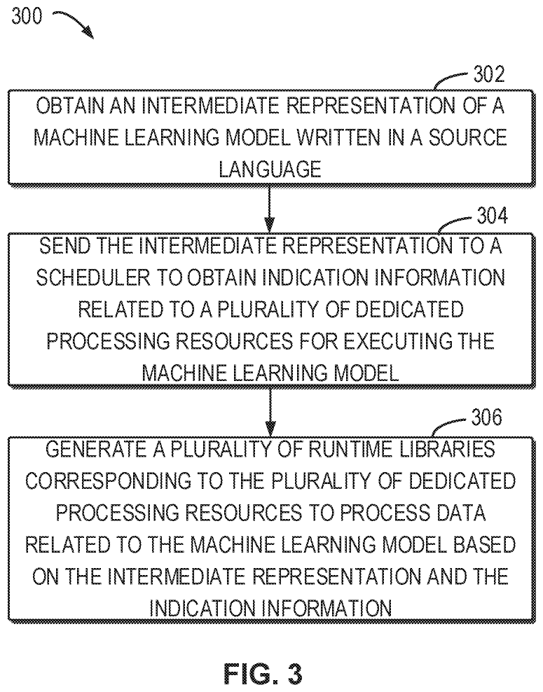

The example environment 100 in which the device and/or method may be implemented according to embodiments of the present disclosure has been described in conjunction with FIGS. 1 and 2. A method 300 of compiling a machine learning model will be described in conjunction with FIG. 3 below.

In some embodiments, the machine learning model may be written in any source language under any framework.

At block 302, the compiler 106 obtains an intermediate representation of the machine learning model 102 written in a source language. The intermediate representation is independent of (i.e., irrelevant to, agnostic with respect to, etc.) the source language and a target language and includes a computation graph described by a structured text. A node in the computation graph represents a function associated with the machine learning model. In some embodiments, the computation graph further includes dependencies between the functions. The dependencies indicate a parameter passing order between the functions. In some embodiments, the intermediate representation of the machine learning model is obtained from the compiler 106 by compiling the machine learning model 102 written in the source language. In some embodiments, the intermediate representation of the machine learning model is written by a programmer according to a compiling rule of a compiler and then obtained by the compiler. The foregoing examples are merely for describing the present disclosure rather than limiting the same. The intermediate representation of the machine learning model may be obtained by any appropriate means.

In some embodiments, the intermediate representation may include a computation graph of a machine learning model to-be-executed which is described in a format of JavaScript object notation (JSON) or extensible markup language (XML).

At block 304, the compiler 106 sends the intermediate representation to the scheduler 108 so as to obtain indication information related to a plurality of dedicated processing resources for executing the machine learning model. In some embodiments, the indication information includes the number of dedicated processing resources for executing the machine learning model and types of the plurality of dedicated processing resources. After obtaining the intermediate representation of the machine learning model 102 written in the source language, the compiler 106 sends the intermediate representation to the scheduler 108.

After obtaining the intermediate representation, the scheduler 108 will determine a computing resource for calculating the machine learning model based on the intermediate representation. In one example, the scheduler 108 may determine a dedicated processing resource for processing a function according to a function in the intermediate representation. The example is merely for describing the disclosure rather than limiting the disclosure, and the scheduler 108 may determine a dedicated processing resource for the machine learning model by any appropriate means. Then, the scheduler 108 sends to the compiler 106 the indication information for the dedicated processing resource use for the machine learning model.

At block 306, the compiler 106 generates a plurality of runtime libraries corresponding to the plurality of dedicated processing resources to process data related to the machine learning model based on the intermediate representation and the indication information, the runtime libraries including functions represented by the target language. In some embodiments, the generated runtime library corresponds to the type of the dedicated processing resource.

The compiler 106 compiles a machine learning model into the runtime library for the type of each dedicated processing resource based on the number and types of dedicated processing resources obtained from the scheduler 108. As a result, the machine learning model may run on any appropriate type of device, thereby improving the general applicability of the compiler.

In some embodiments, the compiler 106 generates one runtime library for each dedicated processing resource used for processing the machine learning model. Alternatively or additionally, each runtime library includes each function in the computation graph of the intermediate representation, i.e., includes all functions in the computation graph.

In some embodiments, the indication information includes information on types of the plurality of dedicated processing resources. The compiler 106 determines a runtime library corresponding to the type of the dedicated processing resources based on the intermediate representation and the type of the dedicated processing resources.

By determining a runtime library based on the type of the dedicated processing resources, it is possible to limit an execution of a program in a compiling stage without using a specific device. Thus, such a type of device is selected in the execution stage of the machine learning model, which improves the availability of the machine learning model.

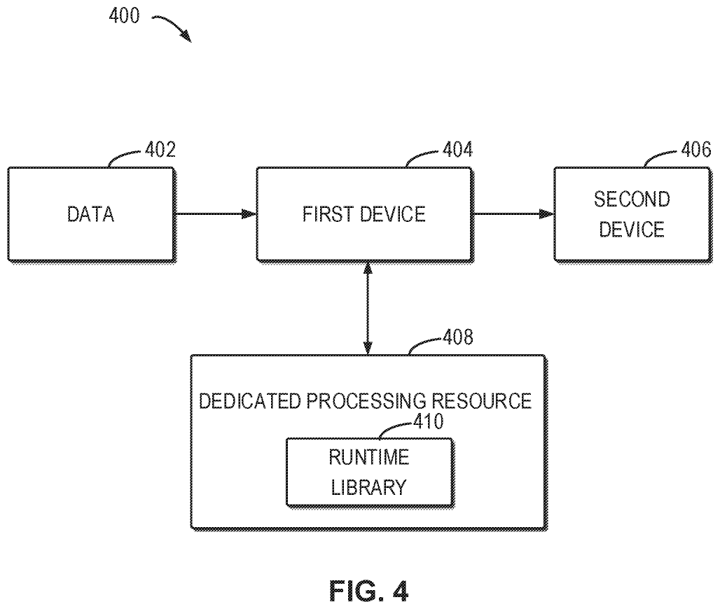

The flowchart of the method 300 for compiling a machine learning model has been described with reference to FIG. 3. Hereinafter, an example environment 400 in which the machine learning model may be executed will be described in conjunction with FIG. 4.

In FIG. 1, the runtime library for the dedicated processing resource is obtained by the compiler 106. In addition, it is further needed to determine a host program running on a host device managing the dedicated processing resource. In some embodiments, with respect to a runtime library running on each dedicated processing resource, there exists one host program, running on a host device, corresponding to the runtime library.

In one example, the host program is generated along with the runtime library by the compiler 106 and then modified by a programmer. In one example, the host program may be generated by the scheduler 108. In another example, the host program may be written by a program developer. These examples are merely for describing the present disclosure rather than limiting the same. The host program running on a host device managing the dedicated processing resource may be determined based on any appropriate method.

The example device 400 shows a first device 404 and a second device 406. Both the first device 404 and the second device 406 are host devices for managing dedicated processing resources. The example above is merely for describing the present disclosure rather than limiting the same. The example environment 400 may include any appropriate number of host devices for managing corresponding dedicated processing resources.

The first device 404 is a host device for managing a dedicated processing resource 408. The host device 404 may be provided as any type of computing device, including but not limited to, a mobile phone laptop computer, a portable computing device, a server, a personal digital assistant (PDA), etc.

The first device 404 receives data 402. In one example, the data 402 may be determined by one or more other devices running the machine learning model. In another example, the data 402 may be data inputted, by a user, for processing by the machine learning model. In a further example, the data 402 may be data obtained from any appropriate device, for processing by the machine learning model. The examples above are merely for illustrating the disclosure rather than limiting the disclosure, and the data 402 may be received from any appropriate device based on any appropriate method.

After receiving the data 402, the first device 404 will send the data 402 to the dedicated processing resource 408 controlled by the first device 404. In some embodiments, when running a host program for processing the machine learning model, the first device 404 will allocate storage space for the dedicated processing resource 408. For example, storage space for the dedicated processing resource 408 is allocated in a memory of the first device 404.

In some embodiments, the first device 404 will wait to receive the data 402. For example, if the first device runs a function of node A202 in FIG. 2, then the first device will wait to receive the data 402 sent by a user for processing by the machine learning model. If the first device 404 runs a function of node B204 in FIG. 2, then the first device has to wait for data sent by a device running node A202. These examples are merely for illustrating the present disclosure rather than limiting the same.

In some embodiments, the first device 404 will store the data 402 in the allocated storage resource after receiving the data 402. Alternatively or additionally, after completing receiving the data 402, an indication indicating completing the receiving of the data also will be received. In some embodiments, the first device 404 sends the data 402 to the dedicated processing resource 408 after receiving the data 402. Alternatively or additionally, the first device 404 sends the data 402 to the dedicated processing resource 408 after receiving the indication indicating completing the receiving of the data.

In some embodiments, the first device 404 may further send, to the dedicated processing resource 408, an indication related to a function of a machine learning model to be run by the dedicated processing resource 408, so that the dedicated processing resource 408 may use the related function to process the data 402. In some examples, the scheduler 108 determines which function is to be processed using the dedicated processing resource 408 of the first device 404. The examples above are merely for illustrating the present disclosure rather than limiting the same, and a function to be processed by the dedicated processing resource 408 of the first device 404 may be set according to needs.

After the dedicated processing resource 408 completes processing the data 402, the first device 404 fetches the processed data and sends the processed data to the second device 406.

In some embodiments, the dedicated processing resource 408 may be a GPU, FPGA or ASIC, etc. On the dedicated processing resource 408 runs a runtime library 410 generated by the compiler 106 in FIG. 1 for this dedicated processing resource. A function of the machine learning model running under the control of the first device 404 comes from this runtime library. Alternatively or additionally, after it is determined the dedicated processing resource 408 processes the machine model, the runtime library generated by the compiler 106, for the dedicated processing resource 408, is then transferred to the dedicated processing resource 408.

The second device 406 is also used to control the dedicated processing resource 408 which runs the function in the machine learning model. The function running in the second device 406 needs to use data which have been processed by the dedicated processing resource 408 of the first device 404.

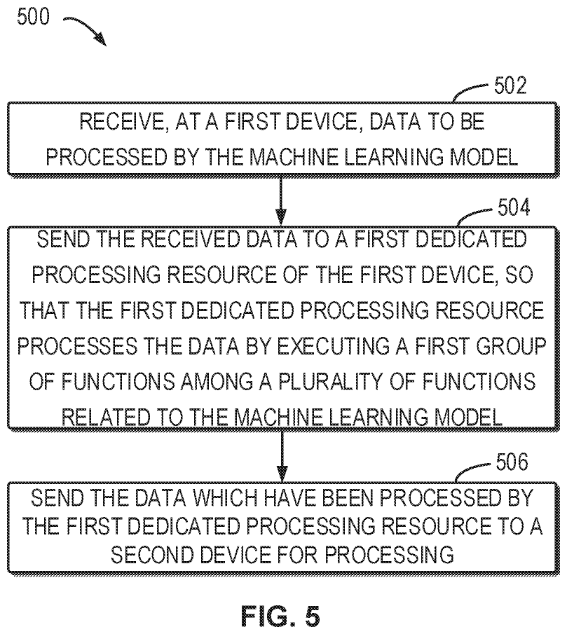

While the environment 400 for executing a machine learning model has been described in conjunction with FIG. 4, a flowchart of a method 500 of processing data by means of the machine learning model will be described in conjunction with FIG. 5 below.

When a plurality of devices are adopted to run the machine learning model, each device runs a host program, which is assigned to the device, to control a corresponding dedicated processing resource to execute different functions of the machine learning model.

At block 502, the data 402 to be processed by the machine learning model are received at the first device 404. In some embodiments, the first device 404 receives the data 402 to be processed from a user. In some embodiments, the first device 404 receives the data 402 from another device, the other device being a device that runs one or more other functions of the machine learning model, and a function input run by the first device 404 being dependent of a function output of the other device. These examples are merely for describing the present disclosure rather than limiting the same.

In some embodiments, when the first device 404 runs a host program for processing the machine learning model, the first device 404 will allocate storage space to the dedicated processing resource 408. For example, storage space for the dedicated processing resource 408 is allocated in a memory of the first device 404. Upon receiving the data 402, the first device 404 will store the received data 402 to storage resources.

At block 504, the received data 402 are sent to the dedicated processing resource 408 for the first device 404, so that the dedicated processing resource 408 processes the data 402 by executing a first group of functions among a plurality of functions related to the machine learning model. The first group of functions executed on the dedicated processing resource 408 is determined by the scheduler 108 analyzing the intermediate representation. Alternatively or additionally, the first group of functions is determined by the scheduler 108 analyzing functions in the intermediate representation. The first group of functions is included in the runtime library 410 accessible to the first device 404, the runtime library 410 being determined by the compiler 106.

In some embodiments, the first device 404 receives first indication information indicating completing the receiving of the data. After receiving the first indication information, the received data 402 are sent to the first dedicated processing resource 408 for the first device 404.

In some embodiments, not only the received data 402 are sent to the dedicated processing resource 408, but also second indication information related to the first group of functions is sent to the dedicated processing resource 408, so that the dedicated processing resource 408 processes the data 402 by executing the first group of functions.

At block 506, the first device 404 sends the data which have been processed by the dedicated processing resource 408 to the second device 406 for processing. The processed data are parameters of a function run by a dedicated processing resource controlled by the second device. The second device 406 is used to control a further dedicated processing resource to process a part of functions of the machine learning model.

In some embodiments, the first device 404 receives data from a third device. The data are determined by a second dedicated processing resource of the third device for executing a second group of functions among the plurality of functions, the second group of functions being included in a second runtime library accessible to the third device, the second runtime library being determined by the scheduler 108.

By using the foregoing method to process a machine learning model, different dedicated processing resources may run the machine learning model simultaneously. By deploying functions of the model to different dedicated processing resources and transmitting function parameters, data passing is solved for different types of devices, so that program developers implement model parallelism without paying attention to layers and framework structure of the model.

In some embodiments, when sending the processed data to the second device 406, first the processed data are obtained from the dedicated processing resource 408; then the processed data are stored in a storage resource. Finally the processed data are sent to the second device 406. If the sending of the processed data is completed, the second indication information is sent to the second device 406 to indicate completion.

By sending the indication information after completion of the data sending, integrity and correctness of data passing results can be ensured, so that a subsequent device can process complete data and the accuracy of the data processing is improved.

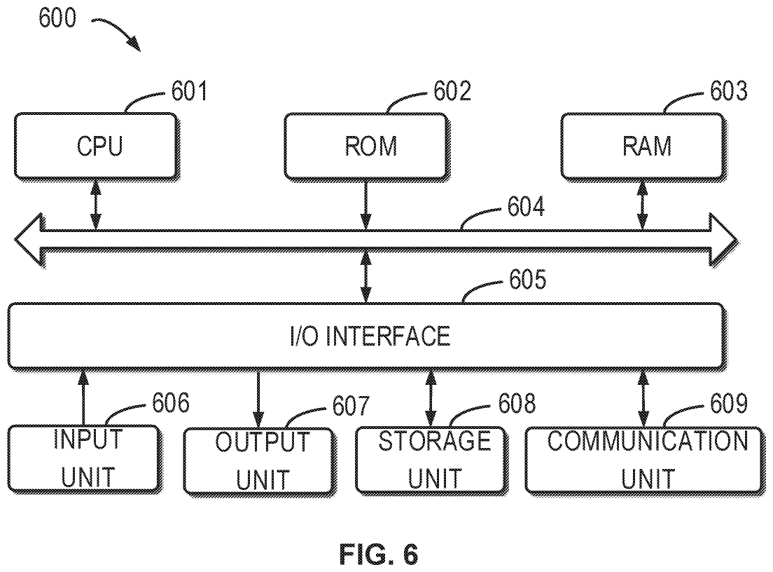

FIG. 6 shows a schematic block diagram of an example device 600 suitable for implementing embodiments of the present disclosure. For example, any of 104, 106 and 108 as shown in FIGS. 1 and 404, 406 and 408 as shown in FIG. 4 may be implemented by the device 600. As shown in the figure, the device 600 includes a central processing unit (CPU) 601 which is capable of performing various appropriate actions and processes in accordance with computer program instructions stored in a read only memory (ROM) 602 or computer program instructions loaded from a storage unit 608 to a random access memory (RAM) 603. In the RAM 603, there are also stored various programs and data required by the device 600 when operating. The CPU 601, ROM 602 and RAM 603 are connected to one another via a bus 604. An input/output (I/O) interface 605 is also connected to the bus 604.

A plurality of components in the device 600 are connected to the I/O interface 605: an input unit 606 such as a keyboard, a mouse, or the like; an output unit 607, such as various types of displays, a loudspeaker or the like; a storage unit 608, such as a disk, an optical disk or the like; and a communication unit 609, such as a LAN card, a modem, a wireless communication transceiver or the like. The communication unit 609 allows the device 600 to exchange information/data with other devices via a computer network, such as the Internet, and/or various telecommunication networks.

The above-described procedures and processes such as the methods 300 and 500 may be executed by the processing unit 601. For example, in some embodiments, the methods 300 and 500 may be implemented as a computer software program, which is tangibly embodied on a machine readable medium, e.g. the storage unit 608. In some embodiments, part or the entirety of the computer program may be loaded to and/or installed on the device 600 via the ROM 602 and/or the communication unit 609. The computer program, when loaded to the RAM 603 and executed by the CPU 601, may execute one or more acts of the methods 300 and 500 as described above.

The present disclosure may be a method, an apparatus, a system, and/or a computer program product. The computer program product may include a computer readable storage medium (or media) having computer readable program instructions thereon for causing a processor to carry out aspects of the present disclosure.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source codes or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an internet service provider). In some embodiments, electronic circuitry including, for example, a programmable logic circuitry, a field-programmable gate arrays (FPGA), or a programmable logic arrays (PLA) may execute the computer readable program instructions by utilizing state information of the computer readable program instructions to personalize the electronic circuitry, in order to perform various aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable data processing apparatus or other device to produce a computer implemented process, such that the instructions which execute on the computer, other programmable data processing apparatus, or other device implement the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to embodiments disclosed. Many modifications and variations will be apparent to those of ordinary skill in the art without departing from the scope and spirit of the described embodiments. The terminology used herein was chosen to best explain the principles of embodiments, the practical application or technical improvement over technologies found in the marketplace, or to enable others of ordinary skill in the art to understand embodiments disclosed herein.

What is claimed is:

1. A method of processing a machine learning model, comprising:
obtaining an intermediate representation of a machine learning model written in a source language, the intermediate representation being independent of the source language and a target language and comprising a computation graph described by a structured text, a node in the computation graph representing a function associated with the machine learning model;
sending the intermediate representation to a scheduler to obtain indication information related to a plurality of dedicated processing resources for executing the machine learning model; and
generating a plurality of runtime libraries corresponding to the plurality of dedicated processing resources to process data related to the machine learning model based on the intermediate representation and the indication information, a runtime library comprising functions represented in the target language.

2. The method according to claim 1, wherein the indication information comprises information related to types of the plurality of dedicated processing resources, and wherein generating the plurality of runtime libraries corresponding to the plurality of dedicated processing resources comprises:
determining the runtime library corresponding to the type of the dedicated processing resource based on the intermediate representation and the type of the dedicated processing resource.

3. The method according to claim 1, wherein the computation graph further comprises dependencies between the functions.

4. A computer program product being tangibly stored on a non-transient computer readable medium and comprising machine executable instructions which, when executed, causing a machine to perform steps of the method according to claim 1.

5. An electronic device for processing a machine learning model, comprising:
a processor; and
a memory storing computer program instructions, the processor running the computer program instructions in the memory to control the electronic device to perform acts, comprising:
obtaining an intermediate representation of a machine learning model written in a source language, the intermediate representation being independent of the source language and a target language and comprising a computation graph described by a structured text, a node in the computation graph representing a function associated with the machine learning model;
sending the intermediate representation to a scheduler to obtain indication information related to a plurality of dedicated processing resources for executing the machine learning model; and
generating a plurality of runtime libraries corresponding to the plurality of dedicated processing resources to process data related to the machine learning model based on the intermediate representation and the indication information, a runtime library comprising functions represented in the target language.

6. The electronic device according to claim 5, wherein the indication information comprises information related to types of the plurality of dedicated processing resources, and wherein generating plurality of runtime libraries corresponding to the plurality of dedicated processing resources comprises:
determining the runtime library corresponding to the type of the dedicated processing resource based on the intermediate representation and the type of the dedicated processing resource.

7. The electronic device according to claim 5, wherein the computation graph further comprises dependencies between the functions.

8. A method of executing a machine learning model, comprising:
receiving, at a first device, data to be processed by the machine learning model;
sending the received data to a first dedicated processing resource of the first device, so that the first dedicated processing resource processes the data by executing a first group of functions among a plurality of functions related to the machine learning model, the first group of functions being comprised in a first runtime library accessible to the first device; and
sending the data which have been processed by the first dedicated processing resource to a second device for processing.

9. The method according to claim 8, wherein sending the received data to the first dedicated processing resource of the first device comprises:
determining whether first indication information indicating completing the receiving of the data is received; and
in response to determining that the first indication information is received, sending the received data to a first dedicated processing resource of the first device.

10. The method according to claim 8, wherein sending the received data to the first dedicated processing resource of the first device comprises:
sending the received data to the first dedicated processing resource; and
sending, to the first dedicated processing resource, second indication information related to the first group of functions, so that the first dedicated processing resource processes the data by executing the first group of functions.

11. The method according to claim 8, wherein receiving the data comprises:
receiving the data from a third device, the data being determined by a second dedicated processing resource of the third device for executing a second group of functions among the plurality of functions, the second group of functions being comprised in a second runtime library accessible to the third device.

12. The method according to claim 8, wherein receiving the data comprises:
allocating a storage resource for storing the data; and
storing the received data in the storage resource.

13. The method according to claim 8, wherein sending the data which have been processed by the first dedicated processing resource to the second device for processing comprises:
obtaining the processed data from the first dedicated processing resource;
storing the processed data in the storage resource;
sending the processed data to a second device; and
in response to completing the sending of the processed data, sending, to the second device, second indication information indicating the completion.

14. A computer program product being tangibly stored on a non-transient computer readable medium and comprising machine executable instructions which, when executed, causing a machine to perform steps of the method according to claim 8.

15. An electronic device for executing a machine learning model, comprising:
a processor; and
a memory storing computer program instructions, the processor running the computer program instructions in the memory to control the electronic device to perform steps according to claim 8.

16. The electronic device according to claim 15, wherein sending the received data to the first dedicated processing resource of the first device comprises:
determining whether first indication information indicating completing the receiving of the data is received; and
in response to determining that the first indication information is received, sending the received data to a first dedicated processing resource of the first device.

17. The electronic device according to claim 15, wherein sending the received data to the first dedicated processing resource of the first device comprises:
sending the received data to the first dedicated processing resource; and
sending, to the first dedicated processing resource, second indication information related to the first group of functions, so that the first dedicated processing resource processes the data by executing the first group of functions.

18. The electronic device according to claim 15, wherein receiving the data comprises:
receiving the data from a third device, the data being determined by a second dedicated processing resource of the third device for executing a second group of functions among the plurality of functions, the second group of functions being comprised in a second runtime library accessible to the third device.

19. The electronic device according to claim 15, wherein receiving the data comprises:
allocating a storage resource for storing the data; and
storing the received data in the storage resource.

20. The electronic device according to claim 15, wherein sending the data which have been processed by the first dedicated processing resource to the second device for processing comprises:
obtaining the processed data from the first dedicated processing resource;
storing the processed data in the storage resource;
sending the processed data to a second device; and
in response to completing the sending of the processed data, sending, to the second device, second indication information indicating the completion.
